(19) United States
(12) Patent Application Publication
(10) Pub. No.: US 2015/0378111 A1
(43) Pub. Date: Dec. 31, 2015

(54) OPTICAL CONNECTOR AND METHOD FOR ASSEMBLING OPTICAL CONNECTOR

(71) Applicant: YAZAKI CORPORATION, Minato-ku, Tokyo (JP)

(72) Inventor: Tomohiro HIKOSAKA, Susono-shi, Shizuoka (JP)

(73) Assignee: YAZAKI CORPORATION, Tokyo (JP)

(21) Appl. No.: 14/758,412

(22) PCT Filed: Jan. 28, 2014
(86) PCT No.: PCT/JP2014/051868

§ 371 Date: Jun. 29, 2015

(30) Foreign Application Priority Data
Jan. 29, 2013 (JP) 2013-014581

(51) Int. Cl. G02B 6/38

(52) U.S. Cl. CPC G02B 6/3874; G02B 6/3825; G02B 6/3887; G02B 6/3821; G02B 6/3869

(57) ABSTRACT

An optical sub harness (11) has an optical fiber cable (13), a ferrule (15) fixed to a fiber end portion (39) of an optical fiber (23) exposed from a jacket (27), a housing (17), a fastening sleeve (19) locked in the housing (17) by a flexible lance (57) and holding the ferrule (15) and the optical fiber (23) inside the housing (17) so as to be displaceable in an axial direction, and a fastening member (21) attached to an outer peripheral surface (115) of a fastening portion (109) provided on the fastening sleeve (19) and fixing a tensile strength material (25) and the jacket (27).

### TECHNICAL FIELD

The present invention relates to an optical connector and a method for assembling the optical connector.

### BACKGROUND ART

As an optical connector used for interconnecting optical fibers for use in automobiles and the like, there is a known optical connector having an optical fiber, a guide ferrule, a spring for stabilizing the position of the ferrule, a ferrule retaining lance, and a housing (see Patent Document 1). As shown in FIG. 7, in an optical connector of this kind, optical fibers are interconnected by a male ferrule 501 and a female ferrule 503. The male ferrule 501 has in a front part thereof an axis portion 511 where an insertion hole 509 for a core (optical fiber) 505b of an optical fiber (optical fiber cable) 505 is formed therethrough and has in a rear part thereof a holding portion 515 that externally holds a covering (jacket) 505a of the optical fiber 505, and a locking portion 517 is formed so as to swell on an intermediate part of the outer periphery of the axis portion 511.

The female ferrule 503 has in a front part thereof an axis portion 513 where the insertion hole 509 for the core 505b is formed therethrough and has in a rear part thereof the holding portion 515 that externally holds the covering 505a of the optical fiber 505, and a shoulder portion 514 is formed on an intermediate part of the outer periphery of the axis portion 513. In front of the shoulder portion 514, a holder 519 as a locking portion is slidably fitted and a spring 521 is wound, and the spring 521 is interposed between a snap ring 523 at the end of the axis portion and the holder 519.

To assemble the male ferrule 501 and the female ferrule 503, first, an end portion of one optical fiber 505 where the covering 505a is stripped off is inserted into the male ferrule, and fixed to the male ferrule 501 by bonding or the like. When this is done, the core 505b is made to protrude from the end of the axis portion 511, and is, for example, cut with a cutter at the end of the axis portion to form a core end face 525. Likewise, an end portion of the other optical fiber 505 where the covering 505a is stripped off is inserted into the female ferrule 503 and fixed to form a core end face 545.

Then, the male ferrule 501 is inserted into a ferrule accommodation chamber 531 from a rear side of a female housing 529 of a female connector 527, and the axis portion 511 is pushed so as to protrude from a fitting surface 533, then a lance 535 is engaged with a rear part of the locking portion 517, so that the male ferrule 501 is prevented from being pulled out rearwardly. On the other hand, the female ferrule 503 is inserted into the ferrule accommodation chamber 531 from a rear side of a male housing 537 and pushed in; then, the lance 535 is engaged with a rear part of the holder 519 pressed against the shoulder portion 514 by the spring 521, so that the female ferrule 503 is prevented from being pulled out rearwardly. Consequently, the axis portion 513 of the female ferrule 503 which is always pushed forward by the elastic force of the spring 521 retracts within the limit of the compression.

Lastly, a male connector 539 is fitted in a hood 541 of the female connector 527, and pushed in until fitting surfaces 533, 543 of these are in contact with each other; then, the axis portion 511 of the male ferrule 501 protruding from the fitting surface 533 passes through an opening and pushes back the axis portion 513 of the female ferrule 503 rearward and the core end faces 525, 545 firmly contact each other by the elastic pushing force of the spring 521, so that signal transmission loss at the connection portion is prevented. This completes the interconnection of the optical fibers.

### PRIOR ART DOCUMENT

### Patent Document

Patent Document 1: JP H7-20362 A

### SUMMARY OF INVENTION

### Problem to be Solved by Invention

However, in the conventional optical connector described above, since the lance 535 is engaged with each of the male ferrule 501 and the female ferrule 503 to thereby prevent them from being pulled out rearwardly from the female housing 529 and the male housing 537, when the optical fiber 505 is pulled by a force equal to or greater than the joining strength between each ferrule and the optical fiber 505, tension is applied to the portion of fixing of the optical fiber 505 and each ferrule, so that the fixing of the optical fiber 505 and the male ferrule 501 or the female ferrule 503 can be broken. If the fixing is broken, the optical fiber 505 moves with respect to the male ferrule 501 or the female ferrule 503 and the core end faces 525, 545 do not firmly contact each other, so that optical connection may not be made. Moreover, some conventional optical connectors are structured so that by the covering and tensile strength material of the optical fiber being finally fixed to the housing, the tension applied to the optical fiber is supported by the housing and is not applied to the portion of fixing of the optical fiber and the ferrule. However, if the optical fiber is inadvertently pulled before the final fixing step where the optical fiber is fixed to the housing, the tension is directly applied to the fixing portion as described above, so that the reliability of the fixing portion can be reduced. For this reason, in the assembly of the optical connector, handling requires care, so that the work becomes cumbersome and productivity is readily reduced.

The present invention is made in view of the circumstances described above, and an object thereof is to provide an optical connector and an optical connector assembling method that enable easy assembly.

### Means for Solving the Problem

The object of the present invention described above is achieved by the following configuration.

(1) An optical connector including an optical fiber cable configured such that an optical fiber and a tensile strength material provided along the optical fiber are covered with a jacket, a ferrule fixed to a fiber end portion of the optical fiber exposed from the jacket, a housing accommodating the ferrule, a fastening sleeve locked in the housing by a flexible lance provided on the housing and holding the ferrule and the optical fiber in the housing so as to be displaceable in an axial direction, and a fastening member attached to an outer peripheral surface of a fastening portion provided on the fastening sleeve and fixing at least one of the tensile strength material and the jacket.

According to the optical connector having the configuration (1) described above, the fastening member is fitted on one end of the optical fiber cable in advance, and the jacket of the cable end portion is removed, so that the optical fiber is exposed from the jacket. The fastening sleeve inside which the optical fiber is passed is fixed to one end of the optical fiber cable by the outer peripheral surface of the fastening portion being covered with at least one of the tensile strength material and the jacket and the outside thereof being tightly fastened by the fastening member. To the fiber end portion of the optical fiber exposed from the fastening sleeve, the ferrule is fixed by bonding or the like. The ferrule assembly includes the ferrule, the optical fiber cable, the fastening sleeve and the fastening member assembled in this manner. Regarding the ferrule assembly fixed to one end of the optical fiber cable, when the fastening sleeve holding the ferrule is inserted in the housing, the fastening sleeve is locked by the flexible lance provided on the housing, so that the fastening sleeve is restricted from being removed rearward from the housing by the flexible lance. Accordingly, when the other end of the optical fiber cable is pulled, the tension is transmitted to the fastening sleeve tightly fastened to the optical fiber cable, and transmitted to the flexible lance locking the fastening sleeve. Further, the tension transmitted to the flexible lance is transmitted to the housing. Thereby, even if the tension is applied to the optical fiber cable where the ferrule assembly is inserted in the housing, the tension does not act on the portion of fixing of the ferrule and the optical fiber at one end of the optical fiber cable, so that the ferrule assembly is protected from inadvertent tension.

(2) The optical connector having the configuration (1) described above, including a spacer incorporated in the housing and engageable with the housing at a temporary locking position to allow an insertion of the fastening sleeve into the housing and at a full locking position to prevent the fastening sleeve from being pulled out.

According to the optical connector having the configuration (2) described above, regarding the connector assembly including the housing and the spacer, when the spacer is in the temporary locking position (pre-assembly condition), the ferrule and the fastening sleeve in the ferrule assembly are insertable into the housing without any interference with the spacer. When the spacer is moved to the full locking position after the ferrule assembly is inserted, the spacer is engaged with the fastening sleeve, so that the ferrule assembly is reliably restricted from being removed rearward from the housing. Accordingly, the assembly of the ferrule assembly to the connector assembly is facilitated. The ferrule and the optical fiber can be displaced in the axial direction also in this fully locked condition.

(3) An optical connector assembling method including steps of fitting a fastening member on a cable end portion of an optical fiber cable, fitting a fastening sleeve on an optical fiber from a distal end side, the optical fiber being exposed by removing a jacket of the cable end portion and, fixing a ferrule to a fiber end portion of the optical fiber on which the fastening sleeve is fitted, fixing, by using the fastening member, at least one of a tensile strength material and the jacket of the cable end portion to an outer peripheral surface of a fastening portion provided on the fastening sleeve, the fastening sleeve holding the ferrule and the optical fiber so as to be displaceable in an axial direction; and assembling including inserting the fastening sleeve holding the ferrule into a housing and locking the fastening sleeve by a flexible lance provided on the housing.

According to the optical connector assembling method having the configuration (3) described above, the fastening member is fitted on the cable end portion of the optical fiber cable in advance, and the jacket of the cable end portion is removed, so that the optical fiber is exposed from the jacket. The fastening sleeve inside which the optical fiber is passed is fixed to one end of the optical fiber cable by the outer peripheral surface of the fastening portion being covered with at least one of the tensile strength material and the jacket and the outside thereof being tightly fastened by the fastening member. To the fiber end portion of the optical fiber exposed from the fastening sleeve, the ferrule is fixed by bonding or the like. The ferrule assembly includes the ferrule, the optical fiber cable, the fastening sleeve and the fastening member assembled in this manner. Regarding the ferrule assembly, when the fastening sleeve holding the ferrule is inserted in the housing, the fastening sleeve is locked by the flexible lance provided on the housing, so that the fastening sleeve is restricted from being removed rearward from the housing by the flexible lance. Accordingly, when the optical fiber cable is pulled, the tension is transmitted to the fastening sleeve tightly fastened to the optical fiber cable, and transmitted to the flexible lance locking the fastening sleeve. Further, the tension transmitted to the flexible lance is transmitted to the housing. Thereby, even if the tension is applied to the optical fiber before the housing and the optical fiber cable are finally fixed, the tension does not act on the portion of fixing of the ferrule and the optical fiber, so that the possibility that inadvertent tension acts on the ferrule assembly is eliminated.

(4) In the optical connector assembling method according having the configuration (3) described above, the assembling step includes a temporary locking step including setting a spacer attached to the housing in a temporary locking position, inserting the fastening sleeve into the housing and locking the fastening sleeve by the flexible lance, and a fully locking step including engaging the spacer at a full locking position with the fastening sleeve to prevent the fastening sleeve from being pulled out.

According to the optical connector assembling method having the configuration (4) described above, even in the temporary locking step where the spacer is in the temporary locking position with respect to the housing, the fastening sleeve is locked by the flexible lance, and the tension applied to the optical fiber cable is transmitted to the housing through the flexible lance. Accordingly, the tension does not act on the portion of fixing of the ferrule and the optical fiber, so that the ferrule assembly is protected from inadvertent tension. When the spacer is moved to the full locking position in the fully locking step after the ferrule assembly is inserted, the spacer is engaged with the fastening sleeve, so that the ferrule assembly is reliably restricted from being removed rearward from the housing. Accordingly, the assembly of the ferrule assembly to the connector assembly is facilitated.

The present invention has been briefly described above. Further, by reading through the mode for carrying out the invention (hereinafter, referred to as “embodiment”) described below with reference to the attached drawings, details of the present invention will be further clarified.

### BRIEF DESCRIPTION OF THE DRAWINGS

FIG. 1 is an exploded perspective view of an optical connector according to an embodiment of the present invention.

FIG. 2 is an exploded perspective view of the optical connector before a ferrule assembly and a connector assembly shown in FIG. 1 are assembled.

FIG. 3A includes a side view of the connector assembly where a spacer shown in FIG. 2 is at a temporary locking position, and FIG. 3 B includes an A-A cross-sectional view of FIG. 3A.

FIG. 4 is a side view of a fastening sleeve.

FIG. 5 is a horizontal cross-sectional view of the optical connector.

FIG. 6 is a longitudinal cross-sectional view explaining an optical connector connection structure connecting the optical connector and a board side housing.

FIG. 7 is a relevant part enlarged view showing an optical fiber joining condition in a conventional optical connector.

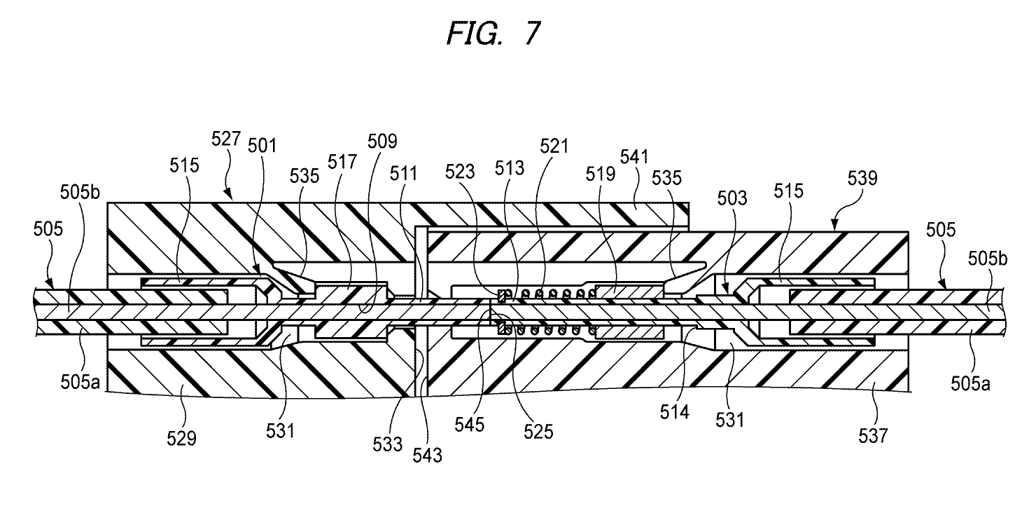

### EMBODIMENTS OF INVENTION

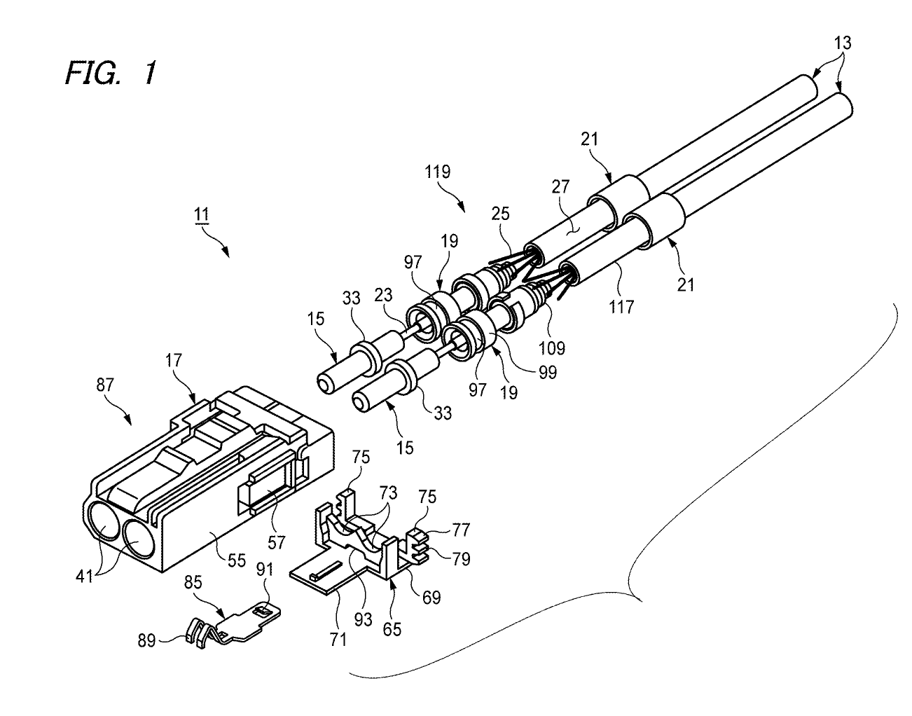

Hereinafter, an embodiment according to the present invention will be described with reference to the drawings. As shown in FIG. 1, an optical sub harness 11 as an optical connector according to the embodiment of the present invention has optical fiber cables 13, ferrules 15, a housing 17, fastening sleeves 19, and fastening members 21.

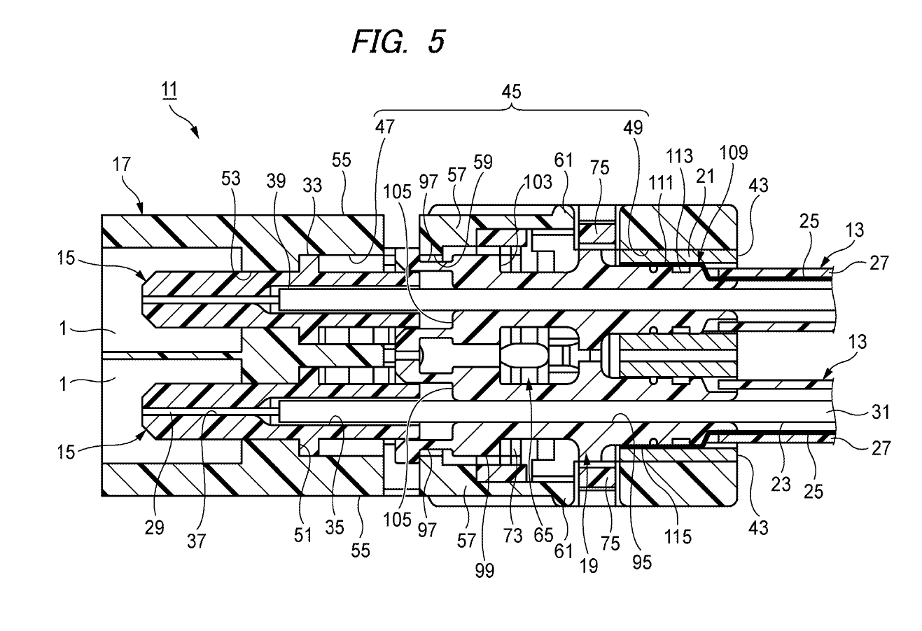

In the optical fiber cable 13, an optical fiber 23 and a tensile strength fiber 25 as a tensile strength material provided along the optical fiber 23 are covered with a jacket 27. The optical fiber 23 has a glass fiber 29 (see FIG. 5) coated with a protective coating 31. On an outer side of the optical fiber 23, the tensile strength fiber 25 is provided therealong (longitudinally). The outer periphery of the tensile strength fiber 25 and the like is further covered with the jacket 27. The tensile strength fiber 25 prevents breakage due to an external force (tensile force) of the glass fiber 29. The tensile strength fiber 25 may be a single fiber, a plurality of fibers or a braid. As the tensile strength fiber 25, an aramid fiber such as a poly-p-phenylene terephthalamide fiber, a polyester fiber such as a polyarylate fiber, a poly-para-phenylene benzbisoxazole fiber and a polyethylene terephthalate fiber, a nylon fiber or the like may be used.

The ferrule 15 is formed in a cylindrical shape, and on the outer periphery substantially in the center in the axial direction, a ferrule flange portion 33 projects in a circular ring shape. Inside the ferrule 15, an optical fiber holding hole 35 (see FIG. 5) is formed so as to be coaxial with the axis line, and the optical fiber holding hole 35 coaxially connects with a fiber insertion hole 37 at the front. To the optical fiber holding hole 35, the optical fiber 23 is fixed by bonding or the like, and the glass fiber 29 exposed by the protective coating 31 of the optical fiber 23 being removed is inserted into the fiber insertion hole 37. That is, the ferrule 15 is fixed to a fiber end portion 39 of the optical fiber 23 exposed from the jacket 27. The glass fiber 29 is, for example, made to protrude from the end of the ferrule 15, and terminated, for example, by being cut with a cutter at the end. The ferrule 15 may be made of any of a metal, a synthetic resin and ceramic (for example, zirconia).

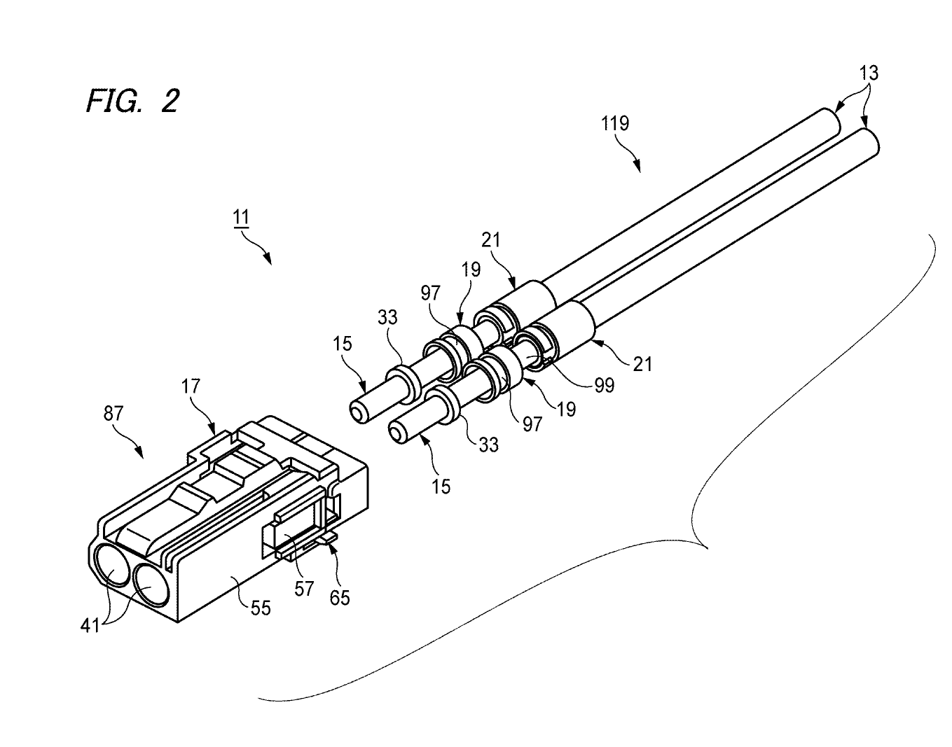

The housing 17 made of a synthetic resin is, as shown in FIG. 1 and FIG. 2, formed substantially in the shape of a rectangular parallelepiped, and a pair of counterpart axial portion fitting holes 41 are opened in the front surface. In the present description, the optical sub harness 11 will be described with the side connected to the counterpart connector as the front and the side from which the optical fiber cable 13 is drawn out as the rear. In the rear surface of the housing 17, a pair of accommodation chamber opening holes 43 (see FIG. 5) are opened, and the accommodation chamber opening holes 43 communicate with ferrule assembly accommodation chambers 45. The front sides of the ferrule assembly accommodation chambers 45 are ferrule accommodation chambers 47, and the rear sides thereof are fastening sleeve accommodation chambers 49. As shown in FIG. 5, in an internal front wall 51 of the ferrule accommodation chamber 47, a ferrule insertion hole 53 is formed. The ferrule 15 the front side of which is inserted through the ferrule insertion hole 53 is restrained from moving further forward by the ferrule flange portion 33 abutting on the internal front wall 51. The ferrule 15 inserted through the ferrule insertion hole 53 is disposed so that the front side thereof is coaxial with the counterpart axial portion fitting hole 41.

As shown in FIG. 1 to FIG. 3A, on a side wall portion 55 on each side of the housing 17, a flexible lance 57 is provided so as to be swingable with respect to the center of swinging extending vertically (see FIG. 5). In the present embodiment, since a pair of ferrule assembly accommodation chambers 45 are formed so as to align side by side, as shown in FIG. 5, the flexible lances 57 provided on the right and left side wall portions 55 are disposed so as to correspond to the right and left ferrule assembly accommodation chambers 45, respectively. The front side of the flexible lance 57 serves as a locking portion 59 and the rear side thereof serves as an unlocking portion 61, and the part between these is supported as the center of swinging. The flexible lance 57 is disposed so that the locking portion 59 protrudes into the fastening sleeve accommodation chamber 49 in a normal state. On the other hand, when the unlocking portion 61 is pressed from the outside of the side wall portion 55, the flexible lance 57 is swung with respect to the center of swinging while being deformed elastically, and the locking portion 59 is moved in a direction in which it exits from the fastening sleeve accommodation chamber 49.

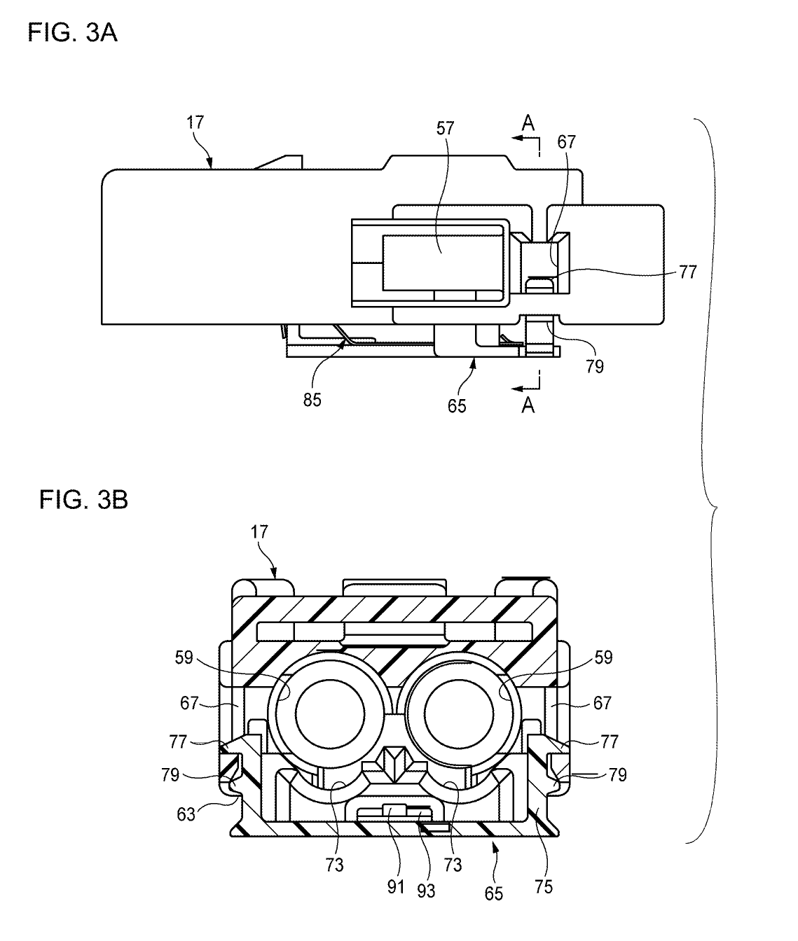

On the lower surface of the housing 17, a spacer attachment open portion 63 is formed. The spacer attachment open portion 63 opens a part on the lower side of the fastening sleeve accommodation chamber 49. Into the spacer attachment open portion 63, a spacer 65 is inserted. On the side wall portion 55 of the housing 17, as shown in FIG. 3A and FIG. 3 B, a locking window portion 67 is provided on a rear side of the flexible lance 57, and the locking window portion 67 is formed in a vertically long longitudinally elongated window shape.

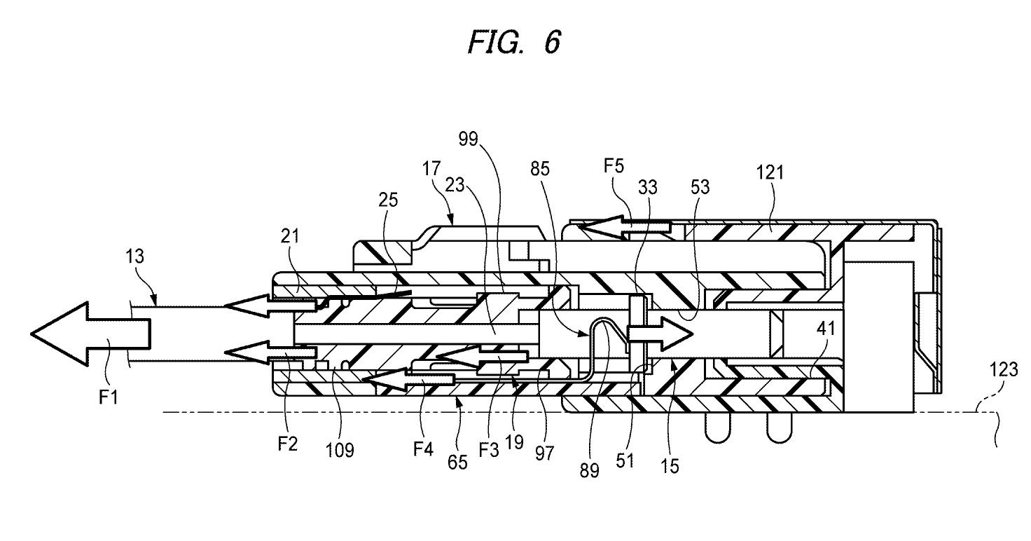

The spacer 65 is formed so as to be substantially T-shaped when viewed two-dimensionally and so that a spring supporting plate 71 extends forward from a central part of a laterally elongated spacer body 69 shown in FIG. 1. On the upper surface of the spacer body 69, a pair of fully locking walls 73 are provided in an uprising state in the direction of the length (the direction of the width of the housing 17). The fully locking walls 73 are each formed so that the upper end side of the uprising is curved in a concave shape. On each side in the direction of the length of the spacer body 69, a fixing wall 75 uprises, and outside each fixing wall 75, a temporary locking protrusion 77 and a full locking protrusion 79 are provided in a protruding state so as to be separated in the vertical direction. The spacer 65 is attached to the housing 17 in a temporary locking position (the position shown in FIG. 3A and FIG. 3B) by the temporary locking protrusions 77 being engaged with the locking window portions 67, and is attached to the housing 17 in a full locking position (the position shown in FIG. 6) by being further pushed into the spacer attachment open portion 63 so that the full locking protrusions 79 are engaged with the locking window portions 67.

To the spring supporting plate 71 of the spacer 65, as shown in FIG. 1, a ferrule pushing spring 85 is attached. That is, the ferrule pushing spring 85 is inserted into the housing 17 from the spacer attachment open portion 63 together with the spacer 65. These housing 17, spacer 65 and ferrule pushing spring 85 form a connector assembly 87. The ferrule pushing spring 85 inserted from the spacer attachment open portion 63 is disposed in the ferrule accommodation chamber 47. The ferrule pushing spring 85 is formed in a plate form elongated in the front-back direction, and on the front side, a flange pressing portion 89 bent in an inverted U shape is formed. The rear side of the ferrule pushing spring 85 where a cut and raised locking piece 91 is formed is engaged with a fixing hole 93 of the spring supporting plate 71 to be held by the spacer 65. The flange pressing portion 89 elastically abuts, from a rear side, on the ferrule flange portion 33 of the ferrule 15 disposed in the ferrule accommodation chamber 47. In this manner, the spacer 65 is assembled in the housing 17, and is engageable with the housing 17 at the temporary locking position to allow the insertion of the fastening sleeve 19 into the housing and at the full locking position to prevent the fastening sleeve 19 from being pulled out.

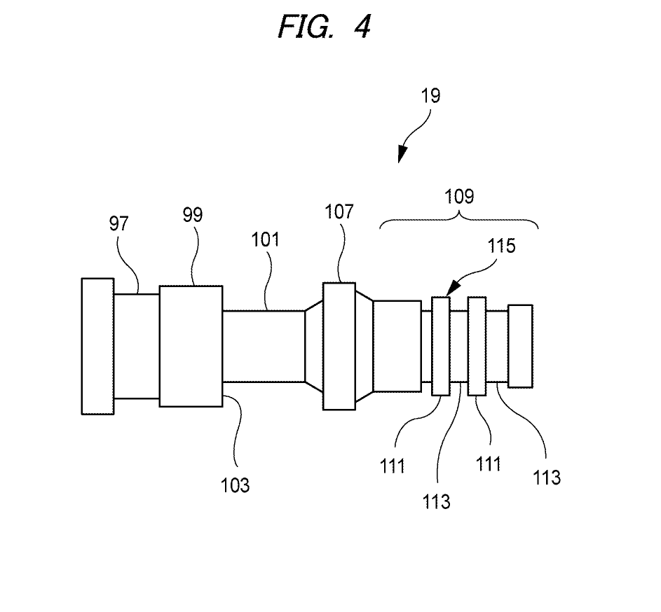

The fastening sleeve 19 made of a synthetic resin (for example, PBT (polybutylene terephthalate)) is formed in a cylindrical shape where a plurality of grooves are formed on the outer periphery, and a fiber insertion hole 95 (see FIG. 5) is formed coaxially with the axis line. On the outer periphery of the front side of the fastening sleeve 19, as shown in FIG. 4, a lance locking groove 97 is formed along the entire perimeter. With the lance locking groove 97, the locking portion 59 of the flexible lance 57 (see FIG. 5) can be engaged. On the outer periphery of the fastening sleeve 19, a large-diameter sleeve portion 99 is formed on a rear side of the lance locking groove 97, and a portion on a rear side of the large-diameter sleeve portion 99 is a spacer engagement concave portion 101. Into the spacer engagement concave portion 101, the fully locking wall 73 of the spacer 65 in the full locking position can enter. The fully locking wall 73 having entered the spacer engagement concave portion 101 abuts on a large diameter portion rear surface 103 of the large-diameter sleeve portion 99.

On the front surface of the fastening sleeve 19, a ferrule reception hole 105 (see FIG. 5) is formed, and at the hole bottom of the ferrule reception hole 105, a fiber insertion hole 95 is opened. That is, to the optical fiber 23 drawn out forward from the fiber insertion hole 95, the ferrule 15 is fixed, and the rear part of the ferrule 15 is held in a state of being accommodated in the ferrule reception hole 105. As described above, the fastening sleeve 19 is locked in the housing 17 by the flexible lance 57 provided on the housing 17, and the fastening sleeve 19 holds the ferrule 15 and the optical fiber 23 in the housing 17 so that they can displace in the axial direction. In the present description, this will be called a floating structure.

As shown in FIG. 4, on the fastening sleeve 19, a portion on a rear side of the spacer engagement concave portion 101 is a large-diameter body portion 107, and on a rear side of the large-diameter body portion 107, a fastening portion 109 is formed. On the fastening portion 109, a plurality of projections 111 and circumferential grooves 113 are formed in the axial direction. An outer peripheral surface 115 of the fastening portion 109 is covered with the tensile strength fiber 25 and the jacket 27 of the optical fiber cable 13.

The fastening member 21 is attached to the outer peripheral surface 115 of the fastening portion 109 covered with the tensile strength fiber 25 and the jacket 27 and is tightly fastened. Thereby, to one end of the optical fiber cable 13, as shown in FIG. 2, the fastening sleeve 19 is fixed.

Next, the method of assembling the optical sub harness 11 according to the present embodiment will be described. In the assembly of the optical sub harness 11, first, as shown in FIG. 1, the fastening member 21 is fitted on a cable end portion 117 of the optical fiber cable 13. Then, the jacket 27 of the cable end portion 117 is removed, so that the optical fiber 23 is exposed from the jacket 27. Then, the fastening sleeve 19 is fitted on the exposed optical fiber 23 from the distal end side.

Then, the ferrule 15 is fixed to the fiber end portion 39 of the optical fiber 23 (see FIG. 5) on which the fastening sleeve 19 is fitted. Then, to the outer peripheral surface 115 of the fastening portion 109 provided on the fastening sleeve 19 where the ferrule 15 and the optical fiber 23 are held so that they can displace in the axial direction, the tensile strength fiber 25 and the jacket 27 of the cable end portion 117 are fixed by the fastening member 21. A ferrule assembly 119 is includes the ferrule 15, the optical fiber cable 13, the fastening sleeve 19 and the fastening member 21 assembled in this manner.

To the housing 17, as shown in FIG. 3A and FIG. 3B, the spacer 65 is attached in the temporary locking position. Moreover, to the spacer 65, the ferrule pushing spring 85 is attached. These are rendered the connector assembly 87. The fastening sleeve 19 holding the ferrule 15 (i.e., the ferrule assembly 119) is inserted into the housing 17 of the connector assembly 87, and the fastening sleeve 19 is locked by the flexible lance 57 provided on the housing 17. This completes the temporary locking step of temporarily assembling the ferrule assembly 119 to the connector assembly 87.

In the temporary locking step, the spacer 65 is attached to the housing 17 in the temporary locking position, the insertion of the fastening sleeve 19 into the housing 17 is enabled, and the fastening sleeve 19 is locked by the flexible lance 57. Then, in the optical sub harness 11, after this temporary locking step, the ferrule assembly 119 is finally locked. In the full locking step, the spacer 65 is moved to the full locking position with respect to the housing 17, and the fully locking wall 73 of the spacer 65 locks the large diameter portion rear surface 103 of the fastening sleeve 19 to prevent the fastening sleeve 19 from being pulled out. This completes the assembly of the optical sub harness 11.

Next, functions of the optical sub harness 11 having the configuration described above will be described. According to the optical sub harness 11 of the embodiment described above, regarding the ferrule assembly 119 fixed to one end of the optical fiber cable 13, when the fastening sleeve 19 holding the ferrule 15 is inserted in the housing 17, the ferrule flange portion 33 abuts on the internal front wall 51 of the housing 17, and the ferrule 15 is restrained from moving further forward. Substantially simultaneously with this, the fastening sleeve 19 is locked by the flexible lance 57 provided on the housing 17, so that the fastening sleeve 19 is restricted from being removed rearward from the housing 17 by the flexible lance 57.

In this case, regarding the connector assembly 87 including the housing 17 and the spacer 65, since the spacer 65 is in the temporary locking position (pre-assembly condition), the ferrule 15 and the fastening sleeve 19 in the ferrule assembly 119 are insertable into the housing 17 without any interference with the spacer 65. Moreover, when the other end (the right end in FIG. 5) of the optical fiber cable 13 is pulled under the condition where the ferrule assembly 119 is inserted in the connector assembly 87, the tension is transmitted to the fastening sleeve 19 tightly fastened to the optical fiber cable 13, and transmitted to the flexible lance 57 locking the fastening sleeve 19. The tension transmitted to the flexible lance 57 is also transmitted to the housing 17. Thereby, even if the tension is applied to the optical fiber cable 13 where the ferrule assembly 119 is inserted in the housing 17, the tension does not act on the portion of fixing of the ferrule 15 and the optical fiber 23 at one end of the optical fiber cable 13, so that the ferrule assembly 119 is protected from inadvertent tension.

As described above, the ferrule 15 is held by its rear part being fitted in the fastening sleeve 19 by the floating structure also in the structure where the tension of the optical fiber cable 13 is transmitted from the fastening sleeve 19 to the housing 17. That is, the ferrule 15 and the optical fiber 23 are held so as to be displaceable in the axial direction irrespective of the tension applied to the optical fiber cable 13.

When the spacer 65 is moved to the full locking position after the ferrule assembly 119 is inserted, the fully locking wall 73 of the spacer 65 is slid from a direction orthogonal to the axis line to abut on the large diameter portion rear surface 103 of the large-diameter sleeve portion 99 on the fastening sleeve 19. Regarding the ferrule assembly 119 inserted in the housing 17 of the connector assembly 87, by the spacer 65 being in the full locking position, the fully locking wall 73 of the spacer 65 abuts on the large diameter portion rear surface 103, so that the ferrule assembly 119 is reliably restricted from being removed rearward from the housing 17. Accordingly, the assembly of the ferrule assembly 119 to the connector assembly 87 is facilitated.

That is, when the optical fiber cable 13 is pulled with the spacer 65 being in the full locking position, as shown in FIG. 6, a tension F1 is transmitted to the fastening sleeve 19 tightly fastened to the optical fiber cable 13 as a tension F2, and is transmitted to the fully locking wall 73 of the spacer 65 that finally locks the fastening sleeve 19 as a tension F3. The tension F3 transmitted to the fully locking wall 73 is transmitted to the housing 17 as a tension F4, and is transmitted to a wiring board 123 to which a board side housing 121 is fixed as a tension F5 through the board side housing 121 of the counterpart connector coupled to the housing 17. In this locking condition, the ferrule 15 and the optical fiber 23 are also displaceable in the axial direction.

Next, effects of the method of assembling the optical sub harness 11 according to the present embodiment will be described. According to the method of assembling the optical sub harness 11 according to the present embodiment, the fastening member 21 is previously fitted on the cable end portion 117 of the optical fiber cable 13, and the jacket 27 at the cable end portion 117 is removed, so that the optical fiber 23 is exposed from the jacket 27. The fastening sleeve 19 inside which the optical fiber 23 is passed is fixed to one end of the optical fiber cable 13 by the outer peripheral surface 115 of the fastening portion 109 being covered with the tensile strength fiber 25 and the jacket 27 and the outside thereof being tightly fastened by the fastening member 21. To the fiber end portion 39 of the optical fiber 23 exposed from the fastening sleeve 19, the ferrule 15 is fixed by bonding or the like. The ferrule assembly 119 includes the ferrule 15, the optical fiber cable 13, the fastening sleeve 19 and the fastening member 21 assembled in this manner. Regarding the ferrule assembly 119, when the fastening sleeve 19 holding the ferrule 15 is inserted in the housing, the fastening sleeve 19 is locked by the flexible lance 57 provided on the housing 17, so that the fastening sleeve 19 is restricted from being removed rearward from the housing 17 by the flexible lance 57.

Under this condition, the spacer 65 is attached in the temporary locking position where the spacer 65 is before it is in the full locking position. The spacer 65 in the temporary locking position never interferes with the fastening sleeve 19. Therefore, even in the temporary locking step where the spacer 65 is in the temporary locking position with respect to the housing 17, the fastening sleeve 19 is locked by the flexible lance 57, and the tension applied to the optical fiber cable 13 is transmitted to the housing 17 through the flexible lance 57. Accordingly, the tension does not act on the portion of fixing of the ferrule 15 and the optical fiber 23, so that the ferrule assembly 119 is protected from inadvertent tension.

Then, when the spacer 65 is moved to the full locking position in the fully locking step after the ferrule assembly 119 is inserted, the fully locking wall 73 of the spacer 65 is slid from the direction orthogonal to the axis line to abut on the large diameter portion rear surface 103 of the large-diameter sleeve portion 99 on the fastening sleeve 19. Regarding the ferrule assembly 119 inserted in the housing 17, by the spacer 65 being in the full locking position, the spacer 65 is engaged with the fastening sleeve 19, so that the ferrule assembly 119 is reliably restricted from being removed rearward from the housing 17. Accordingly, the assembly of the ferrule assembly 119 to the connector assembly 87 is facilitated.

Therefore, according to the optical sub harness 11 of the present embodiment, even if the tension is applied to the optical fiber cable 13 where the ferrule assembly 119 is inserted in the housing 17, the tension does not act on the portion of fixing of the ferrule 15 and the optical fiber 23 (the ferrule assembly 119 is protected from inadvertent tension), so that an optical connector with excellent optical connection can be provided.

Moreover, according to the method of assembling the optical sub harness 11 of the present embodiment, it is unnecessary to perform cumbersome work while taking care so that tension does not act on the portion of fixing of the ferrule 15 and the optical fiber 23 (without any concern that inadvertent tension acts on the ferrule assembly 119), so that assembly work can be performed easily.

The optical connector according to the present invention is not limited to the embodiment described above, and modifications, improvements and the like may be made as appropriate. In addition, the material, configuration, dimensions, number, position of disposition and the like of each element in the embodiment described above are optional as long as the present invention can be attained, and are not limited.

Now, features of the embodiment described above of the optical connector according to the present invention are briefly summarized and listed in the following [1] to [3].

[1] The optical connector (the optical sub harness) 11 includes the optical fiber cable 13 configured such that the optical fiber 23 and the tensile strength material (the tensile strength fiber) 25 provided along the optical fiber 23 are covered with the jacket 27, the ferrule 15 fixed to the fiber end portion 39 of the optical fiber 23 exposed from the jacket 27, the housing 17 accommodating the ferrule 15, the fastening sleeve 19 locked in the housing 17 by the flexible lance 57 provided on the housing 17 and holding the ferrule 15 and the optical fiber 23 in the housing 17 so as to be displaceable in the axial direction; and the fastening member 21 attached to the outer peripheral surface 115 of the fastening portion 109 provided on the fastening sleeve 19 and fixing at least one of the tensile strength material (the tensile strength fiber) 25 and the jacket 27.

[2] The optical connector the (optical sub harness) 11 having the configuration of [1] described above, including the spacer 65 incorporated in the housing 17 and engageable with the housing 17 at the temporary locking position to allow the insertion of the fastening sleeve 19 into the housing 17 and at the full locking position to prevent the fastening sleeve 19 from being pulled out.

[3] The method of assembling the optical connector (the optical sub harness) 11 including steps of fitting the fastening member 21 on the cable end portion 117 of the optical fiber cable 13, fitting the fastening sleeve 19 on the optical fiber 23 from the end side, the optical fiber 23 being exposed by removing the jacket 27 of the cable end portion 117, fixing the ferrule 15 to the fiber end portion 39 of the optical fiber 23 on which the fastening sleeve 19 is fitted, fixing, by using the fastening member 21, at least one of the tensile strength material (the tensile strength fiber) 25 and the jacket 27 of the cable end portion 117 to the outer peripheral surface 115 of the fastening portion 109 provided on the fastening sleeve 19, the fastening sleeve 19 holding the ferrule 15 and the optical fiber 23 so as to be displaceable in the axial direction, and assembling including inserting the fastening sleeve 19 holding the ferrule 15 into the housing 17 and locking the fastening sleeve 19 by the flexible lance 57 provided on the housing 17.

[4] The method of assembling the optical connector (the optical sub harness) 11 having the configuration of [3] described above, wherein the assembling step includes a temporary locking step including setting the spacer 65 attached to the housing 17 in the temporary locking position, inserting the fastening sleeve 19 into the housing 17 and locking the fastening sleeve 19 by the flexible lance 57, and a fully locking step including engaging the spacer 65 at the full locking position with the fastening sleeve 19 to prevent the fastening sleeve 19 from being pulled out.

This application is based on Japanese Patent Application No. 2013-014581 filed on Jan. 29, 2013, the content of which is incorporated herein by reference.

### INDUSTRIAL APPLICABILITY

According to the optical connector of the present embodiment, even if tension is applied to the optical fiber cable where the ferrule assembly is inserted in the housing, the tension does not act on the portion of fixing of the ferrule and the optical fiber (the ferrule assembly is protected from inadvertent tension), so that an optical connector with excellent optical connection can be provided. Moreover, according to the optical connector assembling method of the present embodiment, it is unnecessary to perform cumbersome work while taking care so that tension does not act on the portion of fixing of the ferrule and the optical fiber (without any concern that inadvertent tension acts on the ferrule assembly), so that assembly work can be performed easily.

### DESCRIPTION OF REFERENCE SIGNS

11 . . . optical sub harness (optical connector), 13 . . . optical fiber cable, 15 . . . ferrule, 17 . . . housing, 19 . . . fastening sleeve, 21 . . . fastening member, 23 . . . optical fiber, 25 . . . tensile strength fiber (tensile strength material), 27 . . . jacket, 39 . . . fiber end portion, 57 . . . flexible lance, 65 . . . spacer, 109 . . . fastening portion, 115 . . . outer peripheral surface, 117 . . . cable end portion

1. An optical connector comprising:
an optical fiber cable configured such that an optical fiber and a tensile strength material provided along the optical fiber are covered with a jacket;
a ferrule fixed to a fiber end portion of the optical fiber exposed from the jacket;
a housing accommodating the ferrule;
a fastening sleeve locked in the housing by a flexible lance provided on the housing, the fastening sleeve holding the ferrule and the optical fiber inside the housing so as to be displaceable in an axial direction; and
a fastening member attached to an outer peripheral surface of a fastening portion provided on the fastening sleeve, the fastening member fixing at least one of the tensile strength material and the jacket.

2. The optical connector according to claim 1, comprising a spacer incorporated in the housing and engageable with the housing at a temporary locking position to allow an insertion of the fastening sleeve into the housing and at a full locking position to prevent the fastening sleeve from being pulled out.

3. An optical connector assembling method comprising steps of:
fitting a fastening member on a cable end portion of an optical fiber cable;
fitting a fastening sleeve on an optical fiber from a distal end side, the optical fiber being exposed by removing a jacket of the cable end portion;
fixing a ferrule to a fiber end portion of the optical fiber on which the fastening sleeve is fitted;
fixing, by using the fastening member, at least one of a tensile strength material and the jacket of the cable end portion to an outer peripheral surface of a fastening portion provided on the fastening sleeve, the fastening sleeve holding the ferrule and the optical fiber so as to be displaceable in an axial direction; and
assembling including inserting the fastening sleeve holding the ferrule into a housing and locking the fastening sleeve by a flexible lance provided on the housing.

4. The optical connector assembling method according to claim 3, wherein the assembling step comprises:
a temporary locking step of setting a spacer attached to the housing in a temporary locking position, inserting the fastening sleeve into the housing and locking the fastening sleeve by the flexible lance; and
a fully locking step including engaging the spacer at a full locking position with the fastening sleeve to prevent the fastening sleeve from being pulled out.
